(19) United States
(12) Patent Application Publication
(10) Pub. No.: US 2003/0070093 A1
(43) Pub. Date: Apr. 10, 2003

(54) Method for implementing a server-based, common communication identifier for multiple communication applications

(75) Inventor: Bernard J. Hayes, Fishkill, NY (US)

Correspondence Address: Sean F. Sullivan, Esq., Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 09/974,429

(22) Filed: Oct. 10, 2001

(51) Int. Cl. G06F 12/14; G06F 17/30

(52) U.S. Cl. 713/201; 707/9; 709/219

(57) ABSTRACT

A method for implementing a server-based, common communication identifier for use with multiple communication applications is disclosed. In an exemplary embodiment of the invention, the method includes configuring a server-based repository for storing individual communication location records therein, with each of the individual communication location records corresponding to individual owners thereof. The individual communication location records containing one or more communication location record (CLR) fields therein, with each of the CLR fields corresponding to a specific communication medium by which a particular owner may be contacted. A CLR identifier is assigned for each owner having an individual communication location record stored in said repository. Thereby, a selected CLR field for a given owner is individually accessed by presenting the CLR identifier corresponding to the given owner, along with a CLR field identifier corresponding to the selected CLR field, to the server-based repository.

### BACKGROUND

The present invention relates generally to information management systems and, more particularly, to a method for implementing a single, secure communication identifier for use with multiple, diverse communications applications.

Most electronic communications devices and other related applications such as cell phones, wired telephones, personal digital assistants, e-mail and video mail systems, instant messengers and the like, have a means of storing contact information for various individuals in an address book format. In existing computer systems, each communication application program installed therein typically maintains a separate, private address book. For example, a fax application program usually maintains a fax number address book, while an e-mail application program maintains a separate e-mail address book. An address book is normally stored locally with respect to a device; that is, built-in to the client side of the application for a client server-based application.

Thus, whenever there is a change of address book information with regard to a particular contact or contacts, an individual user will typically manually update any such change in information to the contents of numerous address books on various devices and application clients. As a result, server-based address books have recently been increasing in popularity, since they can ease the user's task of synchronizing various application address books.

However, even with existing server-based address systems, an owner of one or more of the above-mentioned communications devices and/or applications typically has the burdensome task of managing a potential user's access to the various address book fields representing the communication locations where the owner can be reached (e.g., street address, home telephone number, cell phone number, pager number, e-mail address, etc.). Although some of these communication locations (such as home telephone phone number and street address, for example) might be made available to the general public, many others might be intended to be accessed only by a limited set of contacts (users). Furthermore, when one of these communication locations changes or is updated, the owner must then inform all of the users of any such changes/updates so that the users can subsequently manually update their individual address books to keep the information therein current.

### BRIEF SUMMARY

The foregoing discussed drawbacks and deficiencies of the prior art are overcome or alleviated by a method for implementing a server-based, common communication identifier for use with multiple communication applications. In an exemplary embodiment of the invention, the method includes configuring a server-based repository for storing individual communication location records therein, with each of the individual communication location records corresponding to individual owners thereof. The individual communication location records contain one or more communication location record (CLR) fields therein, with each of the CLR fields corresponding to a specific communication medium by which a particular owner may be contacted. A CLR identifier is assigned for each owner having an individual communication location record stored in the repository. Thereby, a selected CLR field for a given owner is individually accessed by presenting the CLR identifier corresponding to the given owner, along with a CLR field identifier corresponding to the selected CLR field, to the server-based repository.

In a preferred embodiment, a public/private status is designated for each of the CLR fields, the public/private status for a given CLR field being determined by the individual owner of the communication location record containing the given CLR field. If the public/private status for the given CLR field is public, then access to the given CLR field is not restricted. However, if the public/private status for the given CLR field is private, then access to the given CLR field is restricted to individuals authorized by the individual owner.

In addition, an access list is configured for each CLR field designated as private, the access list including the individuals authorized to access the corresponding CLR field. A request from a user for access to a selected CLR field for a selected owner is processed by a server that controls the server-based repository. As part of the request for access, the server further receives the CLR identifier corresponding to the selected owner, the CLR field identifier corresponding to the selected CLR field, and a CLR identifier corresponding to the user. Then, the server examines the public/private status of the selected CLR field.

If the public/private status for the selected CLR field is public, then the server allows the user to access information contained in the selected CLR field, regardless of the identity of the CLR identifier corresponding to the user. However, if the public/private status for the selected CLR field is private, then the server compares the CLR identifier of the user to said access list for the selected CLR field. Then, if the access list includes the CLR identifier of the user, then the server allows the user to access information contained in the selected CLR field. If the access list does not include the CLR identifier of the user, then the server does not allow the user to access information contained in the selected CLR field.

### BRIEF DESCRIPTION OF THE DRAWINGS

Referring to the exemplary drawings wherein like elements are numbered alike in the several Figures:

FIG. 1 is a block diagram illustrating a method and system for implementing a server-based, common communication identifier for use with multiple communication applications, in accordance with an embodiment of the invention;

FIG. 2 is a block diagram illustrating the organization of an individual communication location record, as shown in FIG. 1;

FIG. 3 is an exemplary access list for a communication location record (CRL) field designated as “private”;

FIG. 4 is a table illustrating an example of various fields and individuals authorized to access the fields, as designated by an owner of a communication location record; and

FIG. 5 is a flowchart illustrating a process for determining access of a user to a requested field of an owner.

### DETAILED DESCRIPTION

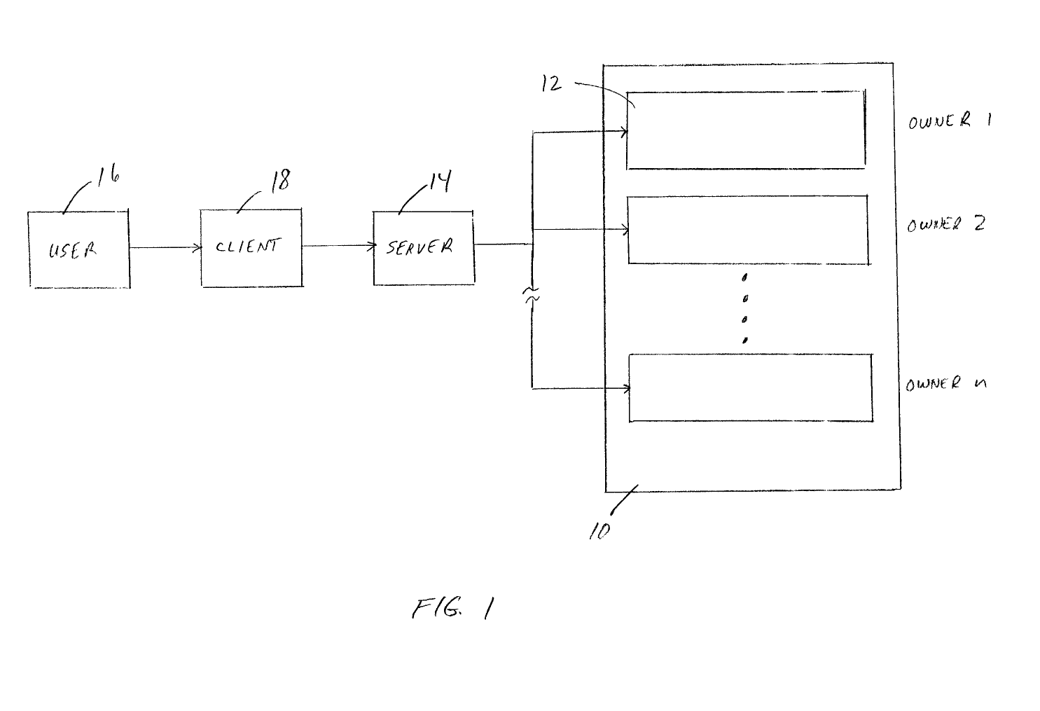

Referring initially to FIG. 1, there is shown a block diagram illustrating a method and system for implementing a server-based, common communication identifier for use with multiple communication applications, in accordance with an embodiment of the invention. A server-based repository 10 (i.e., database) is used for the consolidation and storage of a plurality of individual communication identifiers for an owner. Examples of possible communication identifiers include, but are not limited to, work telephone number, home telephone number, pager number, e-mail address, residence address, etc. Each communication identifier (referred to hereinafter as a field) for a given owner is consolidated within a single communication location record 12, which in turn is stored at an assigned address within repository 10 and is accessible through a server 14.

The repository 10 may contain several communication location records 12 therein, depending upon the number of participants in the system. As will be described in exemplary detail later, a user 16, through a local application or client 18, may attempt to access a particular field for a desired communication location record 12. Client 18 communicates with server 14 which, depending upon the user's authorization, allows access to the field information by the user 16.

Each communication location record 12 is assigned a communication location record (CLR) identifier. The CLR identifier contains information therein pertaining to the specific owner of the communication location record 12, as well as the server address where the communication location record 12 resides in repository 10. For example, the CLR identifier may be of a form such as “John_Doe@address_{—}0001”. Each owner participating in the system will have their CLR identifier publicized. Thereby, each owner to be contacted by an applicable communication medium may potentially be accessed by presenting that owner's single CLR identifier to the server 14.

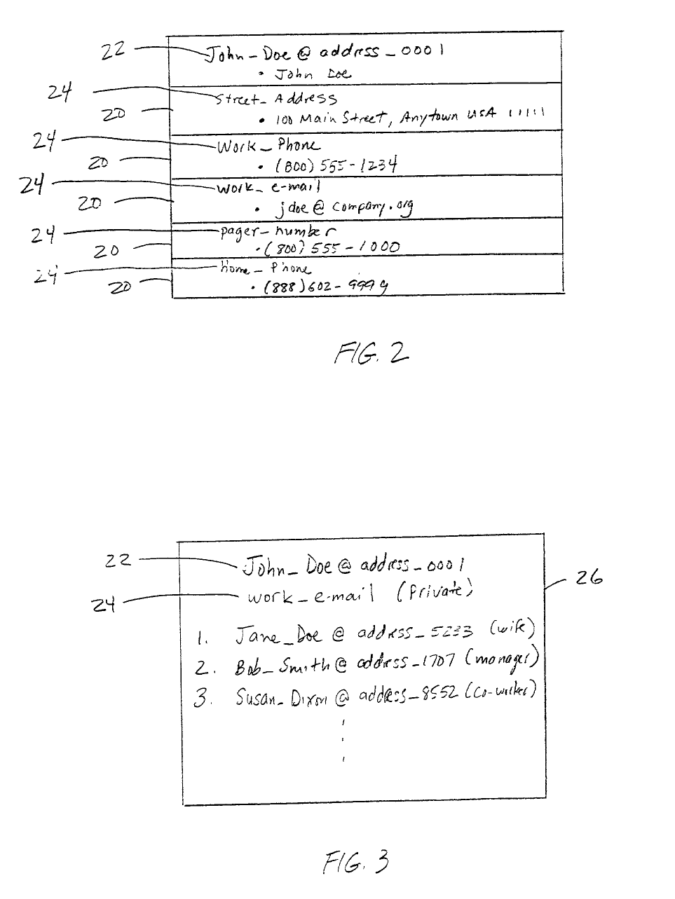

FIG. 2 illustrates the organization of an individual communication location record 12. As is shown, there may be several fields 20 therein, with each field 20 corresponding to a separate communication application by which a record owner may be contacted. Again, the CLR identifier 22 indicates the owner of the communication location record 12 and its address within repository 10. Similar to the CLR identifier 22, each field 20 contained in a communication location record 12 will have a CLR field identifier 24 associated therewith. The CLR field identifiers 24 are preferably consistent with one another from record to record. While every owner in the system might not have all possible communication applications such as, for example, a pager number, each owner that does have a pager number will have a field 20 in their respective communication location record 12 that is identified by a common CLR field identifier 24 (e.g., pager-number).

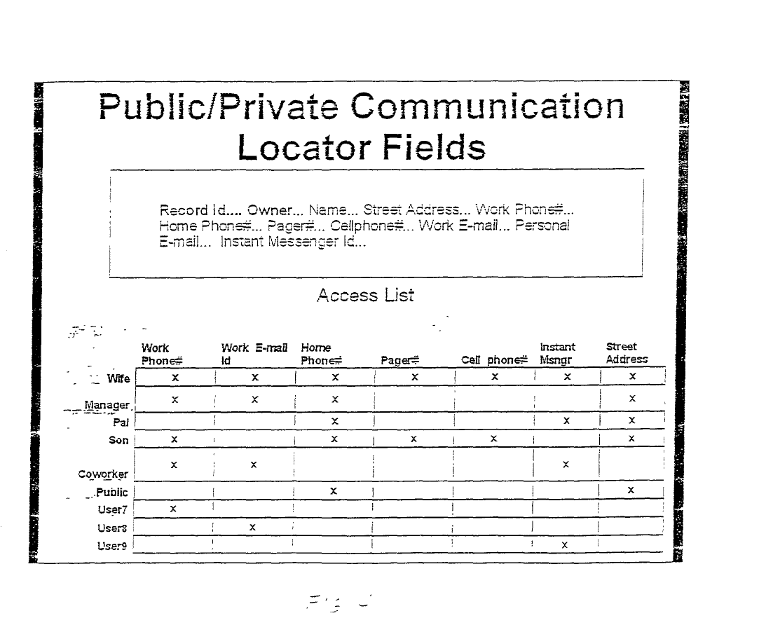

Not every individual who wishes to obtain certain communication information for an owner will have permission to access it. As stated previously, some CLR fields (such as home telephone phone number and street address) might be made available to the general public, but others may be intended by the owner to be accessed only by a limited list of individuals (users). Thus, as illustrated in FIG. 3, each CLR field 20 within a communication location record 12 will have an access list 26 associated therewith. In the representative example shown, the access list 26 for CRL owner John Doe's work e-mail address field includes his wife (Jane Doe), son (John Doe, Jr.), work supervisor and co-workers. Each individual included on the access list 26 will preferably be identified (by server 18) based upon the individual's own CRL identifer.

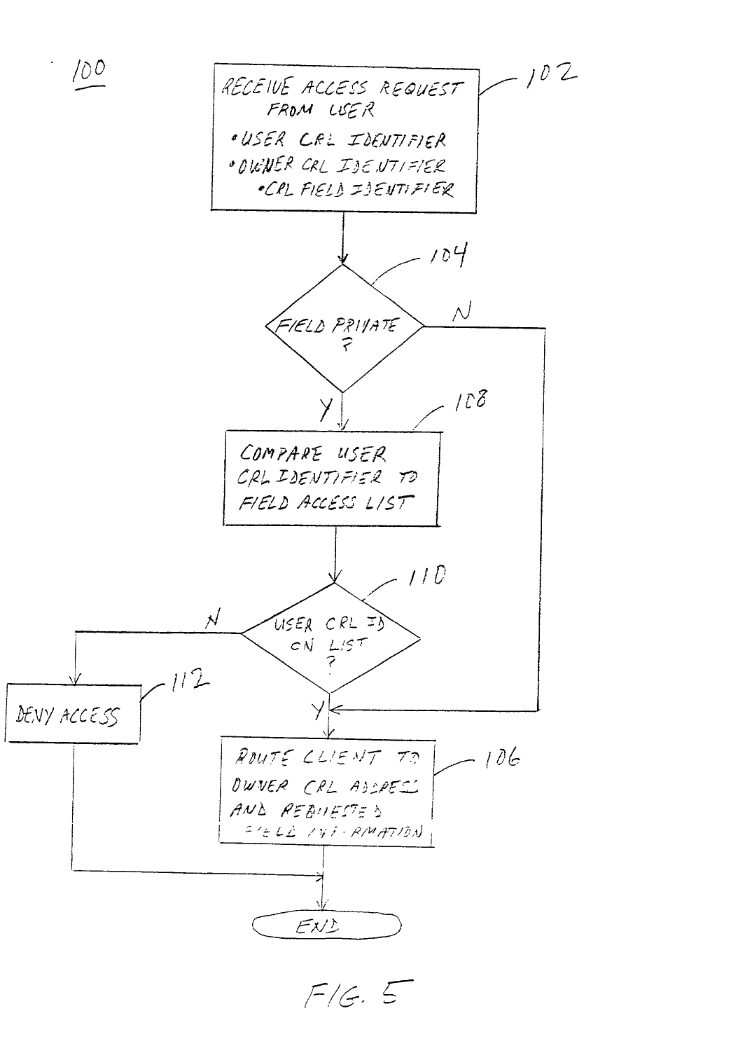

In FIG. 4, there is shown a table 28 that illustrates an example of a possible breakdown of fields and corresponding access lists, the content of the access lists again being designated by the owner of the communication location record 12. It can be seen from FIG. 4 that of the seven fields listed, only the owner's wife has access to each. Two of the fields, the owner's home telephone number and street address are designated as “public” and are thus available to anyone with access to the server 14. All other fields not designated as “public” are therefore designated as “private” by the owner, and will only be accessible to those users included on the applicable access list 26.

Finally, FIG. 5 is a flowchart illustrating an embodiment of a process 100 implemented by the server in managing access to an owner's multiple communication applications (fields). At block 102, the server 14 is contacted by a user 16 (again as shown in FIG. 1) through client 18. The server 14 receives an access request from the user 16 for a selected field for a selected CLR owner. The form of the access request includes the owner's CLR identifier 22, the CLR field identifier 24 and the CLR identifier of the user. Process 100 then proceeds to decision block 104 to see whether the selected field for the selected CLR owner is private. If the field is not private, then process proceeds to block 106 where the server 14 routes the client 18 to the appropriate address of the owner's communication location record 12. The user is then provide with the requested field information, regardless of the user's identity.

On the other hand, if the requested field is private, the process 100 proceeds to block 108 where the server 14 check the access list 26 corresponding to the requested field. If at block 110, it is determined that the user is not on the access list 26, then access to the field information is denied at block 112. However, if the user is on the access list 26, then process 100 proceeds to block 106 and the user is granted access to the field information, as described above.

Through the use of the foregoing system and method for implementing the same, an individual owning multiple and diverse communication devices or attributes may, using a single secure identifier, provide discretionary access to the various address and electronic identifiers used to contact the owner. In addition, an owner of a communication location record may also have real-time update access to the contents of the fields in his or her record. Accordingly, dynamically updated information in the CLR fields thus becomes transparent to the communication application.

The present invention can include embodiments in the form of computer-implemented processes and apparatuses for practicing those processes. The present invention can also include embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also include embodiments in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for implementing a server-based, common communication identifier for use with multiple communication applications, the method comprising:
configuring a server-based repository for storing individual communication location records therein, each of said individual communication location records corresponding to individual owners thereof;
said individual communication location records further containing one or more communication location record (CLR) fields therein, each of said CLR fields corresponding to a specific communication medium by which a particular one of said individual owners may be contacted; and
assigning a CLR identifier for each owner having an individual communication location record stored in said repository;
wherein a selected CLR field for a given owner is individually accessed by presenting the CLR identifier corresponding to said given owner, along with a CLR field identifier corresponding to said selected CLR field, to said server-based repository.

2. The method of claim 1, further comprising:
designating a public/private status for each of said CLR fields, said public/private status for a given CLR field being determined by the individual owner of said communication location record containing said given CLR field;
wherein, if said public/private status for said given CLR field is public, then access to said given CLR field is not restricted; and
if said public/private status for said given CLR field is private, then access to said given CLR field is restricted to individuals authorized by said individual owner.

3. The method of claim 2, further comprising:
configuring an access list for each CLR field designated as private, said access list including the individuals authorized to access the corresponding CLR field.

4. The method of claim 3, wherein:
a request from a user for access to a selected CLR field for a selected owner is processed by a server that controls said server-based repository; and
said server further receiving, as part of said request for access:
the CLR identifier corresponding to said selected owner;
the CLR field identifier corresponding to said selected CLR field; and
a CLR identifier corresponding to said user.

5. The method of claim 4, wherein:
said server examines the public/private status of said selected CLR field, and
if said public/private status for said selected CLR field is public, then said server allows said user to access information contained in said selected CLR field, regardless of the identity of the CLR identifier corresponding to said user;
if said public/private status for said selected CLR field is private, then said server compares the CLR identifier of said user to said access list for said selected CLR field; then
if said access list includes the CLR identifier of said user, then said server allows said user to access information contained in said selected CLR field; and
if said access list does not include the CLR identifier of said user, then said server does not allow said user to access information contained in said selected CLR field.

6. The method of claim 5, wherein said CLR identifier contains a server address therein, said server address corresponding to a location in said server-based repository where the communication location record identified by said CLR identifier is stored.

7. A common communication identifier system for use with multiple communication applications, the system comprising:
a server-based repository for storing individual communication location records therein, each of said individual communication location records corresponding to individual owners thereof;
said individual communication location records further containing one or more communication location record (CLR) fields therein, each of said CLR fields corresponding to a specific communication medium by which a particular one of said individual owners may be contacted; and
a CLR identifier assigned for each owner having an individual communication location record stored in said repository;
wherein a selected CLR field for a given owner is individually accessed by presenting the CLR identifier corresponding to said given owner, along with a CLR field identifier corresponding to said selected CLR field, to said server-based repository.

8. The system of claim 7, further comprising:
a public/private status designated for each of said CLR fields, said public/private status for a given CLR field being determined by the individual owner of said communication location record containing said given CLR field;
wherein, if said public/private status for said given CLR field is public, then access to said given CLR field is not restricted; and
if said public/private status for said given CLR field is private, then access to said given CLR field is restricted to individuals authorized by said individual owner.

9. The system of claim 8, further comprising:
an access list configured for each CLR field designated as private, said access list including the individuals authorized to access the corresponding CLR field.

10. The system of claim 9, wherein:
a request from a user for access to a selected CLR field for a selected owner is processed by a server that controls said server-based repository; and
said server further receiving, as part of said request for access:
the CLR identifier corresponding to said selected owner;
the CLR field identifier corresponding to said selected CLR field; and
a CLR identifier corresponding to said user.

11. The system of claim 10, wherein:
said server examines the public/private status of said selected CLR field, and
if said public/private status for said selected CLR field is public, then said server allows said user to access information contained in said selected CLR field, regardless of the identity of the CLR identifier corresponding to said user;
if said public/private status for said selected CLR field is private, then said server compares the CLR identifier of said user to said access list for said selected CLR field; then
if said access list includes the CLR identifier of said user, then said server allows said user to access information contained in said selected CLR field; and
if said access list does not include the CLR identifier of said user, then said server does not allow said user to access information contained in said selected CLR field.

12. The system of claim 11, wherein said CLR identifier contains a server address therein, said server address corresponding to a location in said server-based repository where the communication location record identified by said CLR identifier is stored.

13. A storage medium encoded with a machine readable computer program code for implementing a server-based, common communication identifier for use with multiple communication applications, the storage medium including instructions for causing a computer to implement a method, the method comprising:
configuring a server-based repository for storing individual communication location records therein, each of said individual communication location records corresponding to individual owners thereof;
said individual communication location records further containing one or more communication location record (CLR) fields therein, each of said CLR fields corresponding to a specific communication medium by which a particular one of said individual owners may be contacted; and
assigning a CLR identifier for each owner having an individual communication location record stored in said repository;
wherein a selected CLR field for a given owner is individually accessed by presenting the CLR identifier corresponding to said given owner, along with a CLR field identifier corresponding to said selected CLR field, to said server-based repository.

14. The storage medium of claim 13, further comprising:
designating a public/private status for each of said CLR fields, said public/private status for a given CLR field being determined by the individual owner of said communication location record containing said given CLR field;
wherein, if said public/private status for said given CLR field is public, then access to said given CLR field is not restricted; and
if said public/private status for said given CLR field is private, then access to said given CLR field is restricted to individuals authorized by said individual owner.

15. The storage medium of claim 14, further comprising:
configuring an access list for each CLR field designated as private, said access list including the individuals authorized to access the corresponding CLR field.

16. The storage medium of claim 15, wherein:
a request from a user for access to a selected CLR field for a selected owner is processed by a server that controls said server-based repository; and
said server further receiving, as part of said request for access:
the CLR identifier corresponding to said selected owner;
the CLR field identifier corresponding to said selected CLR field; and
a CLR identifier corresponding to said user.

17. The storage medium of claim 16, wherein:
said server examines the public/private status of said selected CLR field, and
if said public/private status for said selected CLR field is public, then said server allows said user to access information contained in said selected CLR field, regardless of the identity of the CLR identifier corresponding to said user;
if said public/private status for said selected CLR field is private, then said server compares the CLR identifier of said user to said access list for said selected CLR field; then
if said access list includes the CLR identifier of said user, then said server allows said user to access information contained in said selected CLR field; and
if said access list does not include the CLR identifier of said user, then said server does not allow said user to access information contained in said selected CLR field.

18. The storage medium of claim 17, wherein said CLR identifier contains a server address therein, said server address corresponding to a location in said server-based repository where the communication location record identified by said CLR identifier is stored.

19. A computer data signal for implementing a server-based, common communication identifier for use with multiple communication applications, the computer data signal comprising code configured to cause a processor to implement a method, the method comprising:
configuring a server-based repository for storing individual communication location records therein, each of said individual communication location records corresponding to individual owners thereof;
said individual communication location records further containing one or more communication location record (CLR) fields therein, each of said CLR fields corresponding to a specific communication medium by which a particular one of said individual owners may be contacted; and
assigning a CLR identifier for each owner having an individual communication location record stored in said repository;
wherein a selected CLR field for a given owner is individually accessed by presenting the CLR identifier corresponding to said given owner, along with a CLR field identifier corresponding to said selected CLR field, to said server-based repository.

20. The computer data signal of claim 19, further comprising:
designating a public/private status for each of said CLR fields, said public/private status for a given CLR field being determined by the individual owner of said communication location record containing said given CLR field;
wherein, if said public/private status for said given CLR field is public, then access to said given CLR field is not restricted; and
if said public/private status for said given CLR field is private, then access to said given CLR field is restricted to individuals authorized by said individual owner.

21. The computer data signal of claim 20, further comprising:
configuring an access list for each CLR field designated as private, said access list including the individuals authorized to access the corresponding CLR field.

22. The computer data signal of claim 21, wherein:
a request from a user for access to a selected CLR field for a selected owner is processed by a server that controls said server-based repository; and
said server further receiving, as part of said request for access:
the CLR identifier corresponding to said selected owner;
the CLR field identifier corresponding to said selected CLR field; and
a CLR identifier corresponding to said user.

23. The computer data signal of claim 22, wherein:
said server examines the public/private status of said selected CLR field, and
if said public/private status for said selected CLR field is public, then said server allows said user to access information contained in said selected CLR field, regardless of the identity of the CLR identifier corresponding to said user;
if said public/private status for said selected CLR field is private, then said server compares the CLR identifier of said user to said access list for said selected CLR field; then
if said access list includes the CLR identifier of said user, then said server allows said user to access information contained in said selected CLR field; and
if said access list does not include the CLR identifier of said user, then said server does not allow said user to access information contained in said selected CLR field.

24. The computer data signal of claim 23, wherein said CLR identifier contains a server address therein, said server address corresponding to a location in said server-based repository where the communication location record identified by said CLR identifier is stored.
